(19) United States
(12) Patent Application Publication
(10) Pub. No.: US 2007/0152415 A1
(43) Pub. Date: Jul. 5, 2007

(54) Mobile apparatus for storage and transportation of lawn tools and accessories

(76) Inventor: Robert L. Gunter, Victorville, CA (US)

Correspondence Address: PATENT VENTURE GROUP, 10788 CIVIC CENTER DRIVE, SUITE 215, RANCHO CUCAMONGA, CA, 91730, US

(21) Appl. No.: 11/325,178

(22) Filed: Jan. 3, 2006

(51) Int. Cl. B62B 3/00; B62B 3/10

(52) U.S. Cl. 280/47.35

(57) ABSTRACT

An invention is provided for a mobile storage apparatus. The mobile storage apparatus includes a first body having a top frame, a base frame, and a plurality of guide connectors. Each guide connector extends from the top frame to the base frame, and is configured to accept a handle of a tool. In this manner, tool handles inserted into guide connectors are supported. The mobile storage apparatus further includes a second body attached to the first body. The second body includes a first side panel, a second side panel mounted opposite the first side panel, and a plurality of shelves disposed between the first side panel and the second side panel. In addition, wheels can be situated at the bottom of the mobile storage apparatus to provide easy mobility from point-to-point.

### BACKGROUND OF THE INVENTION

1. Field of the Invention

This invention relates generally to mobile storages devices, and more particularly to a mobile apparatus for storing and transporting lawn tools and accessories.

2. Description of the Related Art

In the lawn care industry, a great variety of tools and accessories are required to properly maintain commercial and residential property. Typically, these tools and accessories must be manually transported from place to place about the lawn or property being maintained. For example, when a homeowner or professional law maintenance worker initiates a particular lawn maintenance project, they must decide which particular items are required to accomplish that particular maintenance project. As a result, the gardener, either professional or non-professional, must make several trips back and forth to gather these items. Moreover, the particular tool or lawn accessory required at a particular time often is not readily available without having to walk a substantial distance to obtain the required item.

For example, common lawn maintenance tools include shovels, hoes, rakes, shears, hoses, electrical cords, trimmers, and gloves. Common gardening accessories include, for example, various chemical fertilizers, herbicides, and pesticides. Since many of these common gardening chemicals are hazardous, the gardener is likely to desire these chemicals to be safely stored such that they do not subsequently contaminate the gardener himself, nor contaminate his tools, equipment, and/or accessories. This process of transporting tools back and forth is time consuming and laborious, along with the fact that most likely only a few tools will be transported at any one time so that normally all the tools required to properly do the job are not always readily available to the gardener where the work is being performed.

After completing maintenance, the conventional prior art solution has been to transport all of the tools and accessories back to the storage facility wherein they where originally stored. For example, rakes and shovels typically are stored on wall racks or stacked against a wall. Gloves and small tools may be placed on a shelf or stored in a drawer.

In response to these issues, prior art gardening wagons have been utilized in an attempt to move more tools to the particular lawn maintenance site. Prior art gardening wagons generally have rectangular bodies with four walls configured to carry items and materials therein. A set of wheels supports the conventional gardening wagon, and a handle can be provided to assist in manual transport of the gardening wagon. The front wheels often are mounted on an axle that is rotatably mounted to the bottom of the wagon body. In this manner, the handle can be mounted to the axle and the cart can be steered by pulling the handle in any desired steering direction, thereby rotating the front axle and aligning the front wheels in that direction.

Unfortunately, conventional gardening wagons fail to provide a means for organizing the various tools and accessories transported by the gardening wagon so that the user may conveniently and safely gain access to each tool and accessory. Gardening wagons often have little more than one open chamber where all of the tools and accessories to be transported are placed, resulting in an unorganized collection of tools that are hard to distinguish and separate. Thus, it is apparent that the prior art gardening wagons do not address the needs associated with groundskeepers or gardeners. For example, prior art gardening wagons cannot hold and transport, at the same time, the various tools accessories in an organized and convenient manner.

In view of the foregoing, there is a need for mobile apparatuses for storage and transportation of lawn tools and accessories. The apparatus should provide both storage and transportation of lawn tools and accessories to relieve the gardener of the need to make several trips back and forth to the storage facility to obtain particular tools required at particular times. In addition, the apparatus should allow for organized storage of tools and accessories to allow the gardener to easily find the required tool for a particular maintenance task. Further, the apparatus should allow for the organized and safe storage of lawn accessories, such as chemicals, gloves, and small lawn tools.

### SUMMARY OF THE INVENTION

Broadly speaking, embodiments of the present invention address these needs by providing a mobile apparatus for storage and transportation of lawn tools and accessories. Embodiments of the present invention allow for a plurality of lawn and garden tools and accessories to be easily stored and moved about the work area utilizing guide connectors as increased support. In one embodiment, a mobile storage apparatus is disclosed. The mobile storage apparatus includes a first body having a top frame, a base frame, and a plurality of guide connectors. Each guide connector extends from the top frame to the base frame, and is configured to accept a handle of a tool. In this manner, tool handles inserted into guide connectors are supported. The mobile storage apparatus further includes a second body attached to the first body. The second body includes a first side panel, a second side panel mounted opposite the first side panel, and a plurality of shelves disposed between the first side panel and the second side panel. In addition, wheels can be substantially attached to a bottom of the mobile storage apparatus to provide easy mobility from point-to-point. For example, two wheels can be attached to the first body and two casters can be attached to the second body to provide steering of the mobile storage apparatus.

An additional mobile storage apparatus is disclosed in a further embodiment of the present invention. In this embodiment, the mobile storage apparatus includes a first body having a top frame, a base frame, and a plurality of guide connectors each extending from the top frame to the base frame. Each guide connector has a first end and a second end, wherein the first end of each guide connector is substantially attached to the top frame and the second end of each guide connector is substantially attached to the base frame. A second body also is included that is attached to the first body. The second body includes a back panel, a first side panel attached to the back panel, and a second side panel mounted opposite the first side panel and attached to the back panel. A plurality of shelves is disposed between the first side panel and the second side panel. Further, a pegboard is attached to the back panel. Typically, the pegboard is configured to mount tool hooks capable of hanging small tools, whereby the hooks can be adjusted. In addition, a plurality of wheels is situated beneath the first body and the second body. These wheels can include casters, for example, two wheels can be attached to the first body, and two casters can be attached to the second body. A small tool tray can also be included that is configured to accept small tool handles, such that a handle of a small tool inserted into the small tool tray is supported. The small tool tray can be mounted anywhere desired, for example, near a top portion of the second body.

Embodiments of the present invention provide a lawn tool storage apparatus that is highly mobile and has provisions thereon for supporting lawn tools and accessories in an organized and readily accessible manner. In addition, the mobile apparatus of the embodiments of the present invention advantageously is relatively devoid of moving parts and therefore is rugged and durable. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a mobile lawn tool storage apparatus, in accordance with an embodiment of the present invention;

FIG. 2 is a cut-away side view of a large tool storage body, in accordance with an embodiment of the present invention;

FIG. 3 is a top view of a large tool storage body, in accordance with an embodiment of the present invention;

FIG. 4 is an illustration showing a rear-view of mobile lawn tool storage apparatus, in accordance with an embodiment of the present invention;

FIG. 5 is an illustration showing a shelving body of a mobile lawn tool storage apparatus, in accordance with an embodiment of the present invention;

FIG. 6 is a side-view of a mobile lawn tool storage apparatus, in accordance with an embodiment of the present invention;

FIG. 7 is an illustration showing a mobile lawn tool storage apparatus having additional small tool storage, in accordance with an embodiment of the present invention; and

FIG. 8 is an illustration showing a mobile lawn tool storage apparatus having additional small tool storage integrated above the top shelf of the shelving body, in accordance with an embodiment of the present invention.

### DETAILED DESCRIPTION OF THE PREFERRED EMBODIMENTS

Embodiments of the present invention provide a novel mobile apparatus for storage and transportation of lawn tools and accessories. Using guide connectors as increased support, embodiments of the present invention allow for a plurality of lawn and garden tools and accessories to be easily stored and moved about the work area. As a result, embodiments of the present invention provide a lawn tool storage apparatus that is highly mobile and has provisions thereon for supporting lawn tools and accessories in an organized and readily accessible manner. Advantageously, the mobile apparatus of the embodiments of the present invention is relatively devoid of moving parts, other than wheels and casters, and therefore is rugged and durable, able to withstand the intended usage.

In addition, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

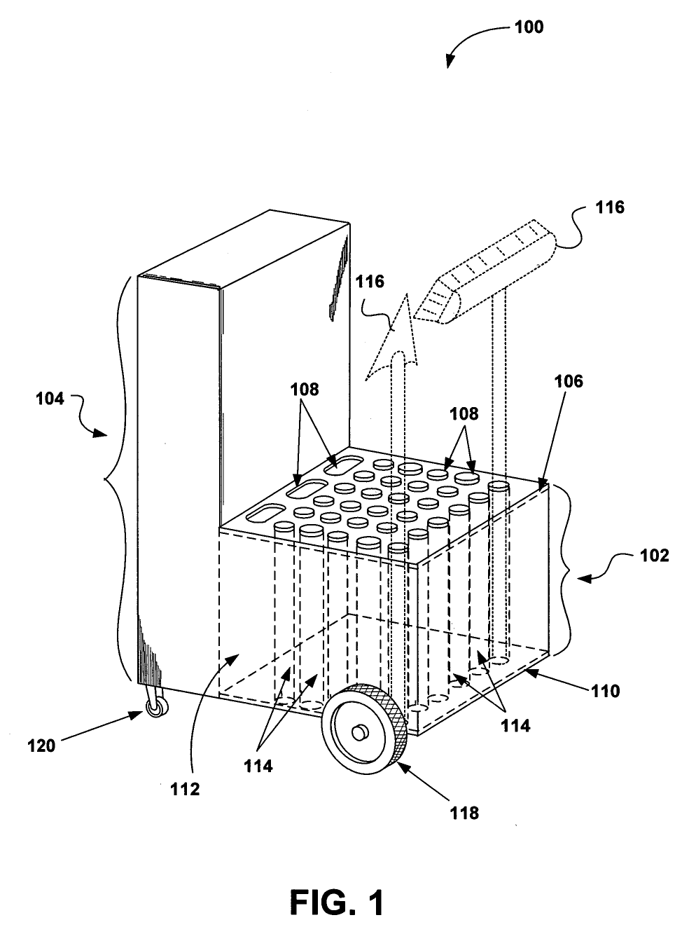

Referring now to the drawings, FIG. 1 is an illustration showing a mobile lawn tool storage apparatus 100, in accordance with an embodiment of the present invention. The mobile lawn tool storage apparatus 100 can be described as comprising two bodies: a large tool storage body denoted generally at 102, and a shelving body denoted generally at 104. Although embodiments of the present invention will be described in terms of two bodies 102 and 104 for ease of reference, it should be noted that in actual practice embodiments of the present invention can be constructed as a single body having the shelving a tool storage elements as will be described below.

The large tool storage body 102 includes a top frame 106 having a plurality of openings 108 disposed in its surface. Opposite the top frame 106 there is disposed a base frame 110. In one embodiment, four side panels 112 provide vertical support and connect the top frame 106 and base frame 110. However, it should be noted that any connection means can be utilized to connect the top frame 106 to the base frame 110, such as corner posts connecting the corners of the top frame 106 and base frame 110, side beams, and any other connection means that will be apparent to those skilled in the art after a careful reading of the present disclosure.

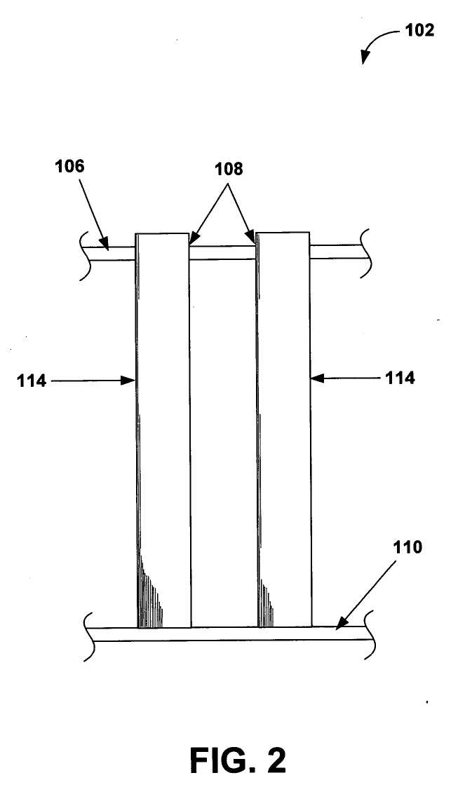

The large tool storage body 102 further includes a plurality of guide connectors 114, illustrated in broken lines, disposed between the top frame 106 and the base frame 110. Each guide connector 114 is disposed within an opening 108 in the top frame 106 and extends to the base frame 110, as illustrated in greater detail in FIG. 2. FIG. 2 is a cut-away side view of a large tool storage body 102, in accordance with an embodiment of the present invention. The cut-away side-view of the large tool storage body 102 shows the top frame 106, base frame 110, and guide connectors 114. As can be seen, each guide connector 114 extends from an opening 108 in the top frame 106 and attaches to the base frame 110. It should be noted that by the term “attaches,” it is meant that each guide connector 114 is affixed to the top and base frames 106 and 110 via any means, such as a washer or other element. Thus, embodiments of the present invention are not limited to attaching the guide connectors 114 directly to the top and base frames 106 and 110.

In one embodiment, each guide connector 114 is tubular in shape and can be of any desired diameter so as to accept a handle of a large lawn or garden tool. For example, in one embodiment, each guide connector 114 can be between 1½″-2″ in diameter. However, it should be borne in mind that the guide connectors 114 can be of any shape that is capable of accepting and supporting a handle of a large lawn or gardening tool. For example, the guide connectors can be square in shape, triangular, hexagonal, or any other shape capable of accepting and supporting a handle of a large lawn or gardening tool as will be apparent to those skilled in the art after a careful reading of the present disclosure.

Referring back to FIG. 1, each guide connector 114 provides support and storage for large lawn or gardening tools 116. More specifically, the size and configuration of the openings 108 and guide connectors 114 are sufficient to afford free entry there through of elongated handles of lawn and garden tools, such as designated by lawn and garden tools 116. The handles of such lawn and garden tools 116 extending through the guide connector 114 to rest on the top surface of the base frame 110. In this manner, embodiments of the present invention provide increased support and storage capacity for large lawn and garden tools. In addition, the guide connectors 114 allow the user to easily insert tools without requiring the user to manually guide the tool handle to the proper resting position on the base frame 114.

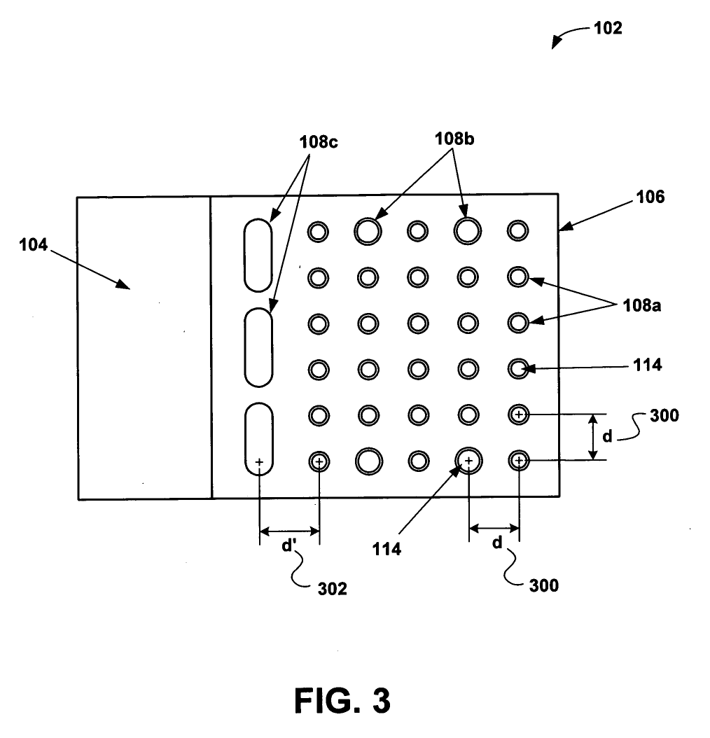

FIG. 3 is a top view of a large tool storage body 102, in accordance with an embodiment of the present invention. As can be seen in FIG. 3, a plurality of openings 108a-108c is disposed within the top frame 106. Guide connectors 114 are situated within openings 108a-108b, attached by adhesive, washers, or any means to the top frame 106. As mentioned above, the size and configuration of the openings 108 and guide connectors 114 are sufficient to afford free entry there through of elongated handles of lawn and garden tools.

In the embodiments of the present invention, the size and shape of the openings 108a-108c and guide connectors 114 can vary to accommodate various sizes of large tools. FIG. 3 illustrates this by showing three exemplary opening sizes. For example, openings 108a in the example of FIG. 3 are configured for shovels, rakes, and other large tools having a standard diameter handle. In this example, openings 108a are about 1½″ in diameter. Openings 108b are configured for tools having larger diameter handles, such as picks. In this example, openings 108b are about 2″ in diameter. Appropriately sized guide connectors 114 are situated in each opening 108a-108b, that is, large guide connectors 114 are situated in the large openings 108b. Openings 108c are configured for tools having irregular handles on one end or multiple handles, such as garden clippers. For example, openings 108c can be 2″ in width and about 4-5″ in length. It should be borne in mind that the above measurements are for exemplary purposes only and should not be construed to limit the scope of the invention in any manner.

The openings 108a-108c are spaced so as to allow easy access to tools stored in the large tool storage body 102. For example, the openings 108a-108b are spaced horizontally and vertically a distance d 300 from each other. In this embodiment, the distance d 300 is about 3.625″. The openings 108c, in the example of FIG. 3, are spaced a distance d′ 302 from the openings 108a. In this embodiment, the distance d′ 302 is about 4.5″. Although the dimensions of the large tool storage body 102 can vary, for exemplary purposes FIG. 3 shows the large tool storage body 102 being about 24.0″ in width and about 26″ in length. The shelving body 104 portion is shown in FIG. 3 to be about 10″ in width, as will be described in greater detail subsequently.

Referring back to FIG. 1, wheels 118 and/or castors 120 are attached to the mobile lawn tool storage apparatus 100 to provide ease of transportation from point to point during use thereof. In one embodiment, casters 120 are mounted on the rear of the mobile lawn tool storage apparatus 100. That is, the casters 120 are mounted below the shelving body 104. The casters 120 can be of any size to provide ease of transportation for the mobile lawn tool storage apparatus 100, for example, FIG. 1 illustrates casters 120 4″ in diameter.

Larger wheels 118 can be mounted on the front of the mobile lawn tool storage apparatus 100, below the large tool storage body 102. As with the casters 120, the wheels 118 can be of any size to provide ease of transportation for the mobile lawn tool storage apparatus 100, for example, FIG. 1 illustrates wheels 118 10″ in diameter. The wheels illustrated in FIG. 1 are about 1¾″ wide and have an axel that is about ½″ in diameter. In one embodiment, the wheels 118 are mounted about 10″ back from the front edge of the mobile lawn tool storage apparatus 100. The wheels 118 and casters 120 afford easy movement on lawn and other rough areas. In use, a user pushes the mobile lawn tool storage apparatus 100 from the shelving body 104 portion of the mobile lawn tool storage apparatus 100, steering utilizing the casters 120.

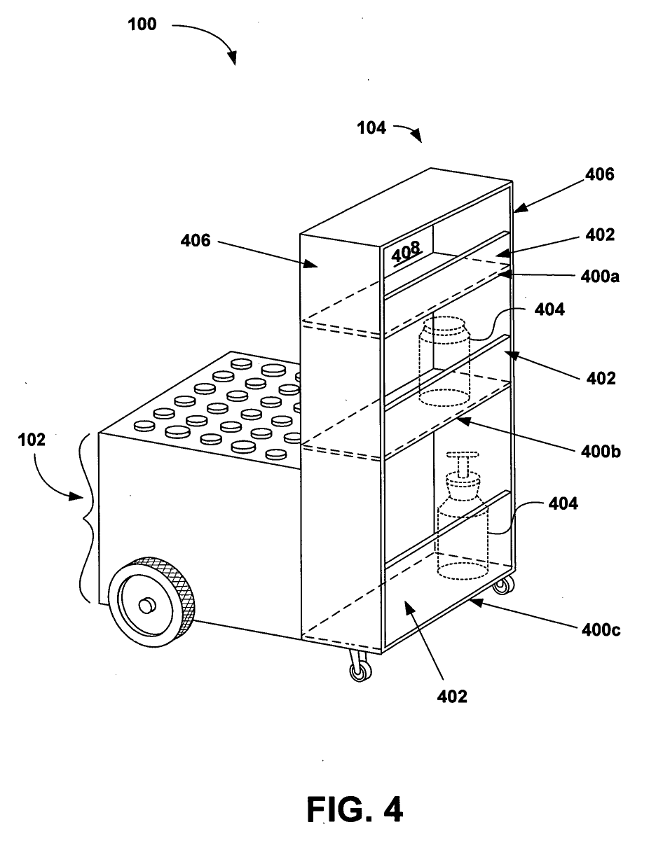

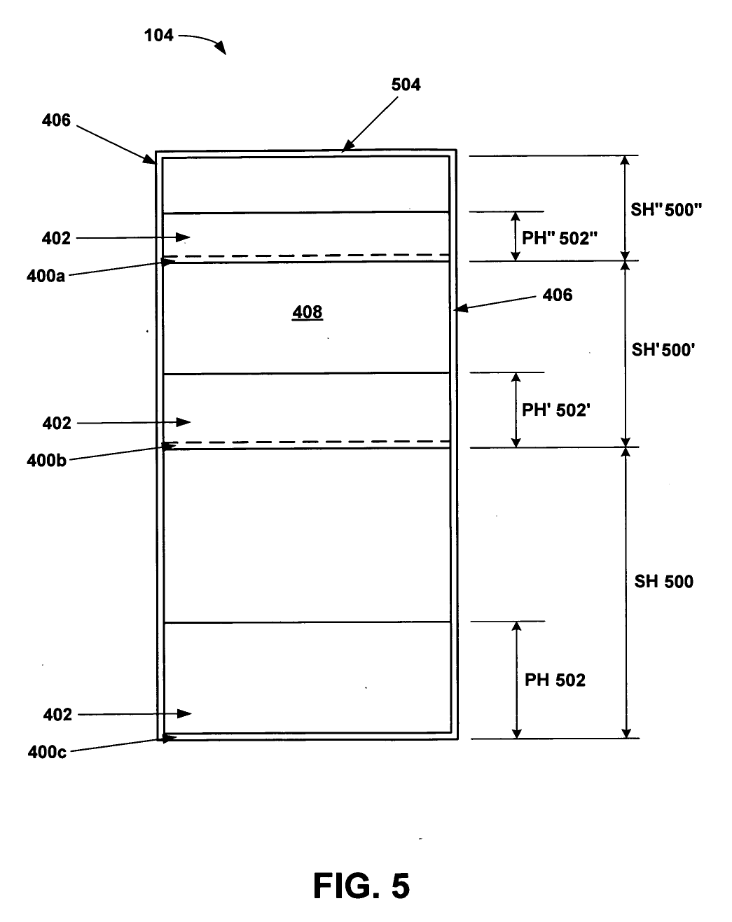

FIG. 4 is an illustration showing a rear-view of mobile lawn tool storage apparatus 100, in accordance with an embodiment of the present invention. As mentioned above, the mobile lawn tool storage apparatus 100 can be described as comprising two bodies: a large tool storage body denoted generally at 102, and a shelving body denoted generally at 104. The shelving body 104 includes two side panels 406 and a back panel 408 enclosing a plurality of shelves 400a-400c. In addition, a protective cover 402 is positioned in front of each shelf 400a-400c. The shelves 400a-400c are configured to afford easy storage and access to a plurality of lawn and garden accessories 404, as described in greater detail next with reference to FIG. 5.

FIG. 5 is an illustration showing a shelving body 104 of a mobile lawn tool storage apparatus 100, in accordance with an embodiment of the present invention. As described above, the shelving body 104 includes two side panels 406 and a back panel 408 enclosing a plurality of shelves 400a-400c, each having a protective cover 402. In addition, embodiments of the present invention may include a top panel 504 above the highest shelf 400a. Although FIG. 4 and FIG. 5 illustrate a shelving body 104 having three shelves, it should be noted that any number of shelves may be included in the shelving body 104, as desired by the user.

In the example of FIG. 5, the lower shelf 400c is configured to hold large accessories and, as such, is configured to have a larger shelf height sh 500 than shelves 400a-400b. For example, in one embodiment, the shelf height sh 500 of shelf 400c is about 22.25″. In this embodiment, the protective cover 402 of shelf 400c has a protective cover height ph 502 of about 9″. The middle shelf 400b, in the example of FIG. 5, is configured to hold medium sized accessories and, as such, is configured to have a shelf height sh′ 500′ of about 14.25″. The corresponding protective cover 402 of shelf 400b has a protective cover height ph′ 502′ of about 5.75″. Finally, the top shelf 400a, in the example of FIG. 5, is configured to hold small accessories and, as such, is configured to have a shelf height sh″ 500″ of about 8.75″. The corresponding protective cover 402 of shelf 400a has a protective cover height ph″ 502″ of about 3.75″. The shelf body 104 can be of any height and width as desired by the user. For example, in FIG. 5 the shelf body 104 has a height of about 46″ and a width of about 22.5″. However, it should be noted that the above measurements are for exemplary purposes only, and should not be construed to limit the scope of the present invention.

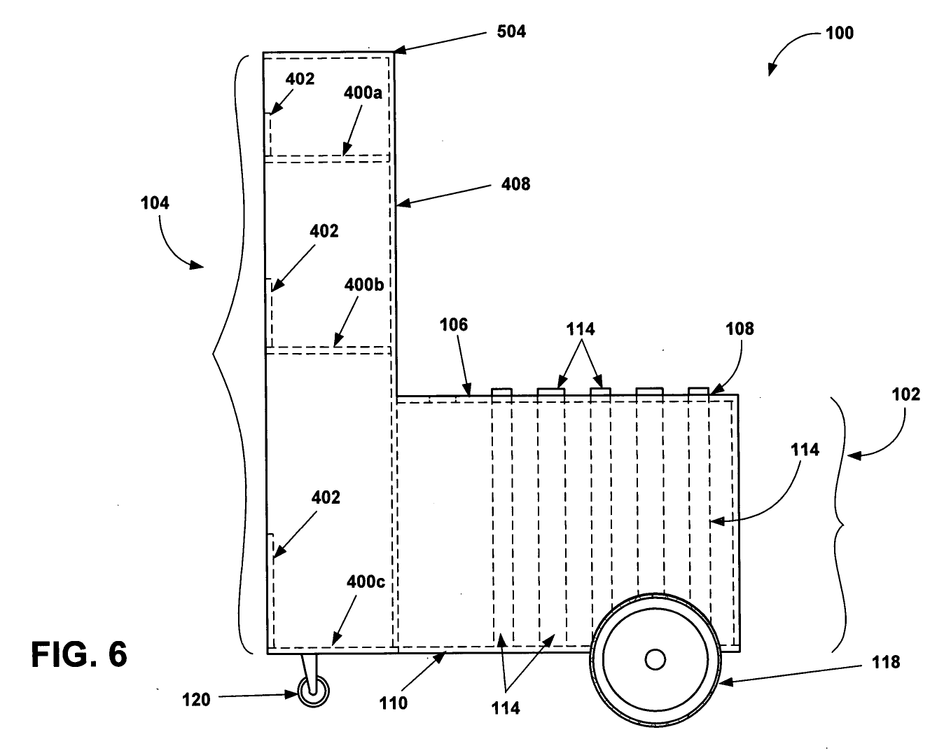

FIG. 6 is a side-view of a mobile lawn tool storage apparatus 100, in accordance with an embodiment of the present invention. As shown in FIG. 6, the mobile lawn tool storage apparatus 100 can be described as comprising two bodies: a large tool storage body denoted generally at 102, and a shelving body denoted generally at 104. The large tool storage body 102 includes a top frame 106 having a plurality of openings 108 disposed in its surface. The base frame 110 is situated opposite the top frame 106. A plurality of guide connectors 114, illustrated in broken lines, is disposed between the top frame 106 and the base frame 110. Each guide connector 114 is situated within an opening 108 in the top frame 106 and extends to the base frame 110.

The shelving body 104 includes two side panels 406, a back panel 408, and a top panel 504 enclosing a plurality of shelves 400a-400c, each having a protective cover 402 positioned in front of each shelf 400a-400c. The shelves 400a-400c are configured to afford easy storage and access to a plurality of lawn and garden accessories 404. For example, as mentioned above, in one embodiment the lower shelf 400c is configured to hold large accessories. The middle shelf 400b is configured to hold medium sized accessories, and the top shelf 400a is configured to hold small accessories.

As described previously, wheels 118 and/or castors 120 are attached to the mobile lawn tool storage apparatus 100 to provide ease of transportation. In one embodiment, the casters 120 are mounted below the shelving body 104, and can be of any size to provide ease of transportation for the mobile lawn tool storage apparatus 100. Larger wheels 118 can be mounted on the front of the mobile lawn tool storage apparatus 100, below the large tool storage body 102. As with the casters 120, the wheels 118 can be of any size to provide ease of transportation for the mobile lawn tool storage apparatus 100. The wheels 118 and casters 120 afford easy movement on lawn and other rough areas.

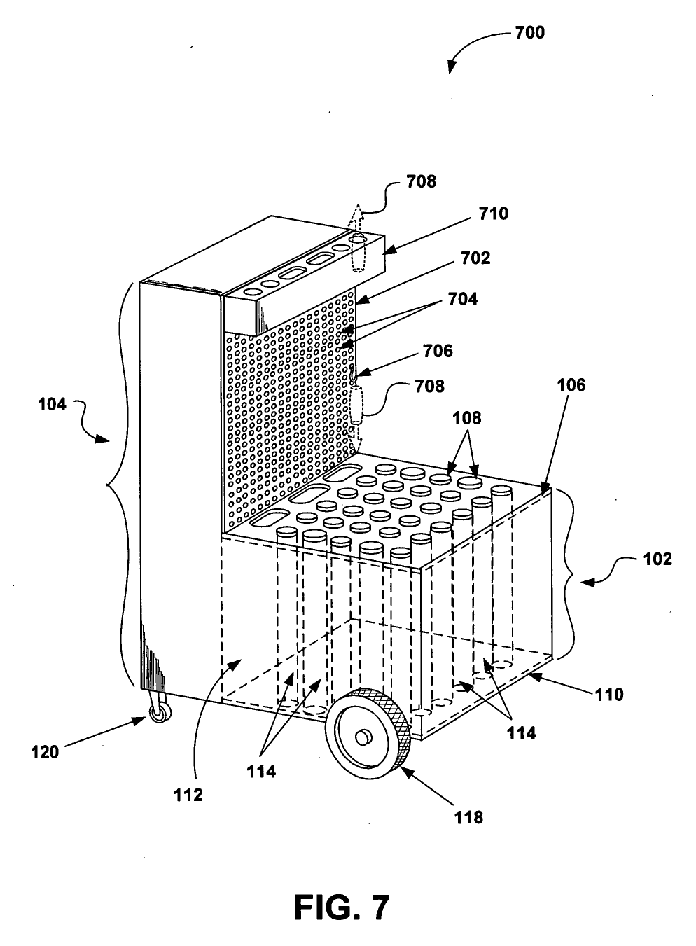

FIG. 7 is an illustration showing a mobile lawn tool storage apparatus 700 having additional small tool storage, in accordance with an embodiment of the present invention. As above, the mobile lawn tool storage apparatus 700 can be described as comprising two bodies: a large tool storage body denoted generally at 102, and a shelving body denoted generally at 104. Although embodiments of the present invention are described in terms of two bodies 102 and 104 for ease of reference, it should be noted that in actual practice embodiments of the present invention can be constructed as a single body having the shelving a tool storage elements as will be described below.

The large tool storage body 102 includes a top frame 106 having a plurality of openings 108 disposed in its surface. Opposite the top frame 106 there is disposed a base frame 110. In one embodiment, four side panels 112 provide vertical support and connect the top frame 106 and base frame 110. However, it should be noted that any connection means can be utilized to connect the top frame 106 to the base frame 110, such as corner posts connecting the corners of the top frame 106 and base frame 110, side beams, and any other connection means that will be apparent to those skilled in the art after a careful reading of the present disclosure.

The large tool storage body 102 further includes a plurality of guide connectors 114, illustrated in broken lines, disposed between the top frame 106 and the base frame 110. Each guide connector 114 is disposed within an opening 108 in the top frame 106 and extends to the base frame 110. Each guide connector 114 provides support and storage for large lawn or gardening tools. More specifically, the size and configuration of the openings 108 and guide connectors 114 are sufficient to afford free entry there through of elongated handles of lawn and garden tools, such as designated by lawn and garden tools. The handles of such lawn and garden tools extending through the guide connector 114 to rest on the top surface of the base frame 110. In this manner, embodiments of the present invention provide increased support and storage capacity for large lawn and garden tools. In addition, the guide connectors 114 allow the user to easily insert tools without requiring the user to manually guide the tool handle to the proper resting position on the base frame 114.

As above, wheels 118 and/or castors 120 are attached to the mobile lawn tool storage apparatus 700 to provide ease of transportation from point to point during use thereof. In one embodiment, casters 120 are mounted on the rear of the mobile lawn tool storage apparatus 100. That is, the casters 120 are mounted below the shelving body 104. The casters 120 can be of any size to provide ease of transportation for the mobile lawn tool storage apparatus 100. Larger wheels 118 can be mounted on the front of the mobile lawn tool storage apparatus 100, below the large tool storage body 102. As with the casters 120, the wheels 118 can be of any size to provide ease of transportation for the mobile lawn tool storage apparatus 100.

In this embodiment, a pegboard 702 is mounted on the back of the shelving body 104. The pegboard 702 includes a plurality of hook holes 704 that can be utilized to mount tool hooks 706. In this manner, smaller hand tools 708 can be hung from the tool hooks 706. Further, the pegboard 702 allows the tool hooks 706 to easily be positioned and repositioned as needed by the user. That is, tool hooks 706 can be added, removed, and repositioned as the make up of the user's tool selection changes.

In addition to the pegboard 702, the mobile lawn tool storage apparatus 700 includes a small tool tray 710 for further storage and transport of small lawn and garden tools. The small tool tray 710 provides organized and easily accessible storage for small lawn and garden tools 708 having handles. Although FIG. 7 shows the small tool storage tray 710 positioned near the top of the shelving body 104, it should be borne in mind that the small tool tray 710 can be mounted in any position on mobile lawn tool storage apparatus 700, such as mid way on the back of the shelving body 104, on a side panel of the large tool storage body 102, or any other suitable area on the mobile lawn tool storage apparatus 700, as will be apparent to those skilled in the art after a careful reading of the present disclosure.

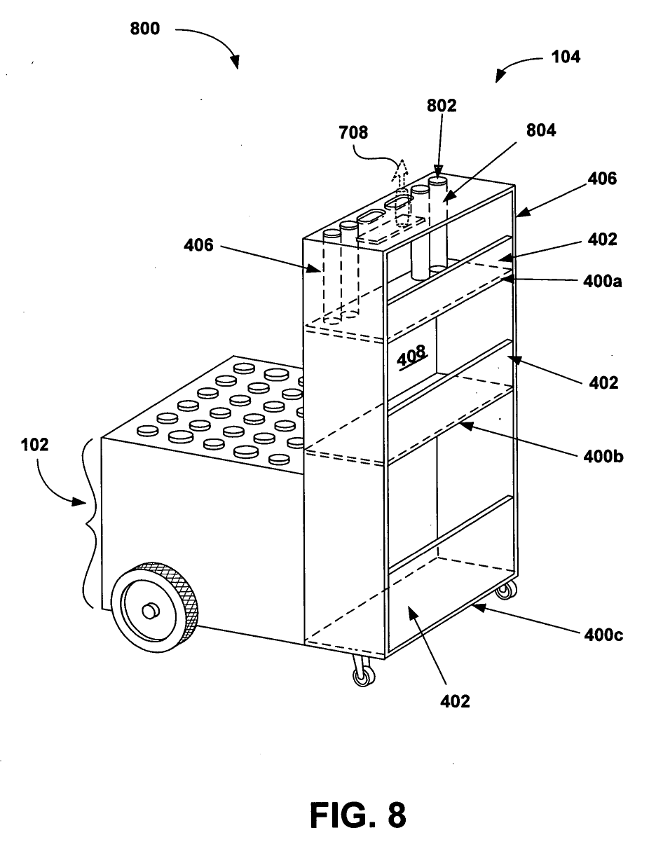

For example, FIG. 8 is an illustration showing a mobile lawn tool storage apparatus 800 having the small tool tray integrated above the top shelf of the shelving body 104, in accordance with an embodiment of the present invention. As above, the mobile lawn tool storage apparatus 800 can be described as comprising two bodies: a large tool storage body denoted generally at 102, and a shelving body denoted generally at 104. The shelving body 104 includes two side panels 406 and a back panel 408 enclosing a plurality of shelves 400a-400c. In addition, a protective cover 402 is positioned in front of each shelf 400a-400c. The shelves 400a-400c are configured to afford easy storage and access to a plurality of lawn and garden accessories 404.

The mobile lawn tool storage apparatus 800 of FIG. 8 also includes a small tool tray that is integrated above the top shelf 408a for further storage and transport of small lawn and garden tools. Similar to FIG. 7, the small tool tray of FIG. 8 provides organized and easily accessible storage for small lawn and garden tools 708 having handles. The small tool storage tray of FIG. 8 includes a plurality of openings 802 connected to small tool guide connectors 804. In addition, the small tool storage tray of FIG. 8 can include openings 802 that are not connected to guide connectors, depending on the needs of the user.

Although the foregoing invention has been described in some detail for purposes of clarity of understanding, it will be apparent that certain changes and modifications may be practiced within the scope of the invention. Accordingly, the present embodiments are to be considered as illustrative and not restrictive, and the invention is not to be limited to the details given. herein, but may be modified within scope and equivalents of the invention.

What is claimed is:

1. A mobile storage apparatus, comprising:
a first body having a top frame, a base frame, and a plurality of guide connectors, each guide connector extending from the top frame to the base frame, wherein each guide connector is configured to accept a handle of a tool, whereby the tool handle inserted into a guide connector is supported; and
a second body attached to the first body, the second body having a first side panel, a second side panel mounted opposite the first side panel, and a plurality of shelves disposed between the first side panel and the second side panel.

2. A mobile storage apparatus as recited in claim 1, wherein each guide connector is essentially tubular in shape.

3. A mobile storage apparatus as recited in claim 1, wherein the top frame includes a plurality of openings, wherein each opening in a subset of the plurality of openings is configured to accept a guide connector.

4. A mobile storage apparatus as recited in claim 1, further comprising a plurality of wheels substantially attached to a bottom of the mobile storage apparatus.

5. A mobile storage apparatus as recited in claim 4, wherein the plurality of wheels includes casters.

6. A mobile storage apparatus as recited in claim 5, wherein the plurality of wheels includes two wheels substantially attached to the first body, and two casters substantially attached to the second body.

7. A mobile storage apparatus as recited in claim 1, further comprising a pegboard attached to the second body.

8. A mobile storage apparatus as recited in claim 7, wherein the pegboard is configured to mount tool hooks cable of hanging small tools, whereby the tool hooks can be adjusted.

9. A mobile storage apparatus as recited in claim 1, further comprising a small tool tray configured to accept small tool handles, whereby a handle of a small tool inserted into the small tool tray is supported.

10. A mobile storage apparatus, comprising:
a first body having a top frame, a base frame, and a plurality of guide connectors each extending from the top frame to the base frame, each guide connector having a first end and a second end, wherein the first end of each guide connector is substantially attached to the top frame and the second end of each guide connector is substantially attached to the base frame, whereby a tool handle inserted into a guide connector is supported;
a second body attached to the first body, the second body having a back panel, a first side panel attached to the back panel, a second side panel mounted opposite the first side panel and attached to the back panel, a plurality of shelves disposed between the first side panel and the second side panel, and a pegboard attached to the back panel; and
a plurality of wheels situated beneath the first body and the second body.

11. A mobile storage apparatus as recited in claim 10, further comprising a small tool tray configured to accept small tool handles, whereby a handle of a small tool inserted into the small tool tray is supported.

12. A mobile storage apparatus as recited in claim 11, wherein the small tool tray is mounted near a top portion of the second body.

13. A mobile storage apparatus as recited in claim 10, wherein each guide connector is essentially tubular in shape.

14. A mobile storage apparatus as recited in claim 10, wherein the top frame includes a plurality of openings, wherein each opening in a first subset of the plurality of openings is configured to accept a guide connector.

15. A mobile storage apparatus as recited in claim 14, wherein a second subset of the plurality of openings is configured to accept tools having multiple handles, wherein guide connectors do not extend through the second subset of the plurality of openings.

16. A mobile storage apparatus as recited in claim 10, wherein the plurality of wheels includes casters.

17. A mobile storage apparatus as recited in claim 16, wherein the plurality of wheels includes two wheels substantially attached to the first body, and two casters substantially attached to the second body.

18. A mobile storage apparatus as recited in claim 10, wherein the pegboard is configured to mount tool hooks cable of hanging small tools, whereby the tool hooks can be adjusted.
